(19) United States
(12) Patent Application Publication
(10) Pub. No.: US 2012/0119668 A1
(43) Pub. Date: May 17, 2012

(54) LIGHT EMITTING ELEMENT DRIVER AND MOBILE DEVICE

(75) Inventors: Katsushi Sumisaki, Osaka (JP); Toshihiko Taniguchi, Nara (JP); Tsunemi Yoshino, Nara (JP)

(73) Assignee: Panasonic Corporation, Osaka (JP)

(21) Appl. No.: 13/387,143

(22) PCT Filed: Aug. 2, 2010
(86) PCT No.: PCT/JP2010/004860

§ 371 Date: Jan. 26, 2012

(30) Foreign Application Priority Data
Aug. 4, 2009 (JP) 2009-181411
Feb. 1, 2010 (JP) 2010-020066

(51) Int. Cl. H05B 37/02

(52) U.S. Cl. 315/240

(57) ABSTRACT

A light emitting element driver includes: a light emitting element; driving means; an electric accumulation element; and a battery power supply that can supply electric power to the driving means and the electric accumulation element, wherein the driving means is configured so as to be able to switch between a state in which the electric accumulation element accumulates the electric power supplied from the battery power supply and a state in which the electric accumulation element supplies the accumulated electric power to the light emitting element, the driving means connects the electric accumulation element and the light emitting element in parallel to each other with respect to the battery power supply when the electric accumulation element accumulates the electric power supplied from the battery power supply, and the driving means connects the battery power supply, the electric accumulation element, and the light emitting element in series when the electric accumulation element supplies the accumulated electric power to the light emitting element. According to the above configuration, a light emitting element driver that can achieve the miniaturization of the apparatus and a mobile device are provided.

### TECHNICAL FIELD

The present invention relates to a driver that drives a light emitting element used in a stroboscope of a camera and the like and a mobile device provided with the light emitting element driver.

### BACKGROUND ART

Conventionally, as illustrated in FIG. 6, there is well known light emitting element driver 1 including light emitting element 2, driving means 3 that drives light emitting element 2, a plurality of electric accumulation elements 4 in each of which electric power can be stored, and battery power supply 5 that can supply the electric power to driving means 3 and electric accumulation element 4. Light emitting element driver 1 also includes camera unit 6 that can capture an image, controller 7 that controls the whole apparatus, step-up unit 8 that steps up the electric power supplied from battery power supply 5, and balance resistor 9 that causes the plurality of series-connected electric accumulation elements 4 to equally accumulate the electric power.

Driving means 3 includes inverter 10 and first and second switches (CMOS) 11 and 12, whereby driving means 3 is configured so as to be able to switch between a state (hereinafter referred to as an “electric accumulation state”) in which electric accumulation element 4 accumulates the electric power supplied from battery power supply 5 and a state (hereinafter referred to as an “discharge state”) in which electric accumulation element 4 supplies the accumulated electric power to light emitting element 2 (for example, refer to PTL 1). The electric accumulation state and the discharge state will be described below.

In the electric accumulation state, when controller 7 outputs an L signal, the L signal is applied to an input of inverter 10 to apply an H signal to an input of a gate of first switch 11, thereby turning on (closing) first switch 11. On the other hand, because the L signal is applied to the input of the gate of second switch 12, second switch 12 is turned off (opened). Because current i1 is passed through a closed loop of first switch 11, step-up unit 8, and electric accumulation element 4 from battery power supply 5, each electric accumulation element 4 accumulates the electric power supplied from battery power supply 5.

In the discharge state, when controller 7 outputs the H signal in order to operate a circuit, the H signal is applied to the input of inverter 10 and the L signal is applied to the input of the gate of first switch 11, thereby turning off (opening) first switch 11. On the other hand, the H signal is applied to the input of the gate of second switch 12, thereby turning on (closing) second switch 12. Because current i2 is passed through a closed loop of each electric accumulation element 4, light emitting element 2, and second switch 12, each electric accumulation element 4 supplies the electric power to light emitting element 2, whereby light emitting element 2 emits the light.

### CITATION LIST

### Patent Literature

PTL 1: Unexamined Japanese Patent Publication No. 2007-108545

Incidentally, in light emitting element driver 1 illustrated in FIG. 6, for example, a voltage value of 3.6 V of the electric power can be supplied from battery power supply 5, and a voltage value of 2.5 V of the electric power can be supplied from each electric accumulation element 4. On the other hand, it is necessary that a voltage value of 4.0 V of the electric power in which light emitting element 2 emits the light be higher than the voltage values at battery power supply 5 and each electric accumulation element 4. Therefore, step-up unit 8 is disposed or the plurality of electric accumulation elements 4 are connected in series.

Specifically, in the electric accumulation state, the electric power of the voltage value of 3.6 V supplied from battery power supply 5 is stepped up to the voltage value of 5.0 V by step-up unit 8, which allows two electric accumulation elements 4 and 4 to accumulate the electric power until the additional voltage value becomes 5.0 V. In the discharge state, two electric accumulation elements 4 and 4 discharge the electric power of the additional voltage value of 5.0 V, and the electric power of the voltage value higher than the voltage value that can be supplied by battery power supply 5 or one electric accumulation element 4 is supplied to light emitting element 2, so that light emitting element 2 can emit the light.

However, the apparatus is enlarged when step-up unit 8 is disposed or when the plurality of electric accumulation elements 4 are connected in series. Even if battery power supply 5 that can supply the higher voltage value is used in order to eliminate step-up unit 8, the apparatus cannot smoothly be miniaturized because battery power supply 5 is enlarged, and battery power supply 5 that can supply the higher voltage value may cause cost increase.

In view of the foregoing, the present invention provides a light emitting element driver that can achieve the miniaturization of the apparatus and a mobile device.

### SUMMARY OF THE INVENTION

A light emitting element driver according to the present invention includes: a light emitting element; driving means for driving the light emitting element; an electric accumulation element that can accumulate electric power; and a battery power supply that can supply the electric power to the driving means and the electric accumulation element, wherein the driving means is configured so as to be able to switch between a state in which the electric accumulation element accumulates the electric power supplied from the battery power supply and a state in which the electric accumulation element supplies the accumulated electric power to the light emitting element, the electric accumulation element and the light emitting element are connected in parallel to each other with respect to the battery power supply when the electric accumulation element accumulates the electric power supplied from the battery power supply, and the battery power supply, the electric accumulation element, and the light emitting element are connected in series when the electric accumulation element supplies the accumulated electric power to the light emitting element.

According to the above configuration, the step-up unit can be eliminated, or the voltage value of the electric power supplied to the light emitting element by the electric accumulation element can be decreased.

In the light emitting element driver according to the present invention, the electric accumulation element may be an electric double layer capacitor.

According to the above configuration, compared with other material that can accumulate the electric power, the electric double layer capacitor is compact while an electric accumulation capacity is large, so that the apparatus can further be miniaturized.

In the light emitting element driver according to the present invention, the driving means may further include an over-electric-accumulation preventing unit that stops the battery power supply from supplying the electric power to the electric accumulation element when the electric accumulation element accumulates the electric power to a predetermined voltage value. According to the above configuration, over-electric-accumulation (over-charge) of the electric accumulation element is prevented, so that the damage (breakage) of the electric accumulation element can be prevented.

The light emitting element driver according to the present invention may include: an RF (Radio Frequency) circuit to which the battery power supply supplies the electric power when radio communication is conducted with an outside; and a light emission preventing unit that prevents the electric power from being supplied to the light emitting element.

According to the above configuration, a stop or a malfunction of the RF circuit, which is caused by a deficiency in voltage, can be prevented or insufficient light emission of the light emitting element, which is caused by the deficiency in voltage, can be prevented.

The mobile device according to the present invention may further include: an optical system that focuses light; and a light receiving element that receives the light focused by the optical system.

According to the above configuration, the voltage value, which can be supplied to the light emitting element while the voltage value of the electric power of the battery power supply and the voltage value of the electric power of the electric accumulation element are added, is set larger than the voltage value at which the light emitting element emits the light, which allows the light emitting element to emit the light. Therefore, advantageously the miniaturization of the apparatus can be achieved.

### BRIEF DESCRIPTION OF DRAWINGS

FIG. 1A is a perspective view of an entire mobile device according to a first exemplary embodiment of the present invention.

FIG. 1B is a perspective view of the entire mobile device according to the first exemplary embodiment of the present invention when viewed from a different direction.

FIG. 2 is a circuit diagram of a light emitting element driver according to the first exemplary embodiment of the present invention.

FIG. 3 is a circuit diagram of a light emitting element driver according to a second exemplary embodiment of the present invention.

FIG. 4 is a circuit diagram of a light emitting element driver according to a third exemplary embodiment of the present invention.

FIG. 5 is a circuit diagram of a light emitting element driver according to a fourth exemplary embodiment of the present invention.

FIG. 6 is a circuit diagram of a conventional light emitting element driver.

### DESCRIPTION OF EMBODIMENTS

### First Exemplary Embodiment

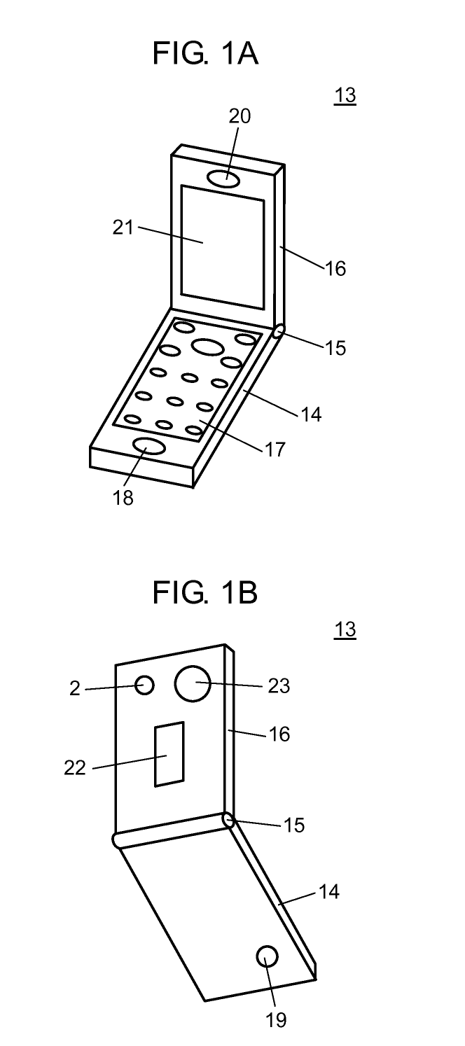

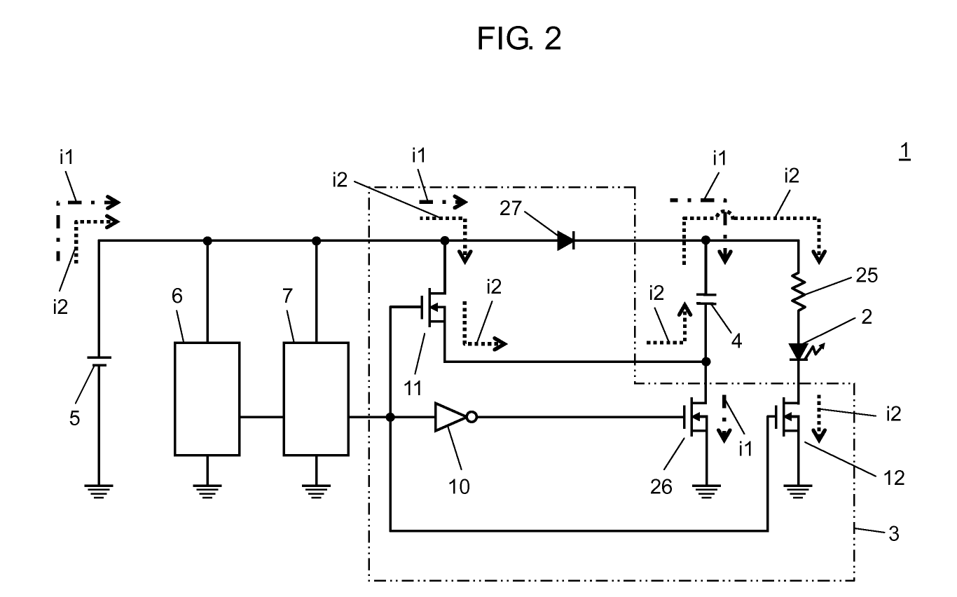

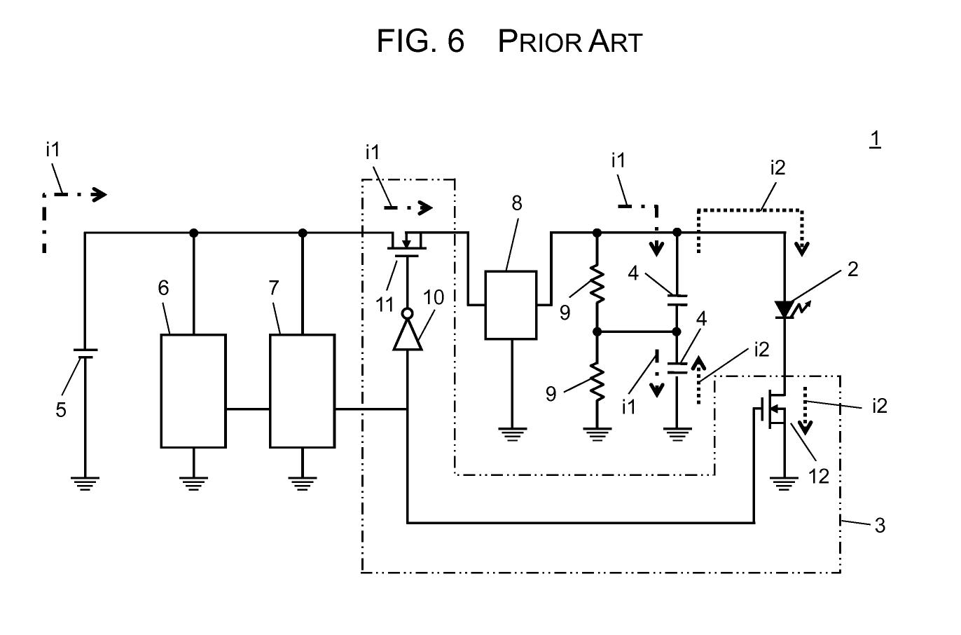

A light emitting element driver and a mobile device according to a first exemplary embodiment of the present invention will be described below with reference to FIGS. 1A, 1B, and 2. In FIGS. 1A, 1B, and 2, the same configuration or component as that of FIG. 6 is designated by the same reference numeral as the conventional technology unless otherwise noted.

As illustrated in FIGS. 1A, 1B, and 2, mobile device 13 of the first exemplary embodiment is a mobile phone that is equipped with an LED flash function and a digital camera function by including light emitting element driver 1. Mobile device 13 includes first main body 14 and second main body 16, and first main body 14 and second main body 16 are foldable through hinge mechanism 15.

First main body 14 includes manipulation key unit 17 and microphone 18, which are located on an inner surface side of mobile device 13 when mobile device 13 is folded. Manipulation key unit 17 includes numerical keys and the like, and inputs a manipulation of mobile device 13. Microphone 18 inputs transmission sound. First main body 14 includes sounder 19, which is located on an outer surface side of mobile device 13 when mobile device 13 is folded, and sounder 19 notifies a user of an incoming state.

Second main body 16 includes speaker 20 and first display 21, which are located on the inner surface side of mobile device 13 when mobile device 13 is folded. Speaker 20 outputs receiver sound, and first display 21 displays a character and an image. Second main body 16 includes second display 22, light emitting element 2, and optical system 23, which are located on an outer surface side of mobile device 13 when mobile device 13 is folded. Similarly to first display 21, second display 22 displays the character and the image, light emitting element 2 emits light, and optical system 23 focuses light (light from light emitting element or sunlight) reflected by a subject. In the first exemplary embodiment, an objective lens is used in optical system 23.

In addition to light emitting element 2, light emitting element driver 1 includes driving means 3 that drives light emitting element 2, electric accumulation element 4 in which electric power can be accumulated, and battery power supply 5 that can supply the electric power to driving means 3 and electric accumulation element 4. Light emitting element driver 1 includes camera unit 6, controller (CPU) 7, and limiting resistor 25. Camera unit 6 that can capture the image includes a light receiving element (not illustrated) that receives the light focused by optical system 23, controller 7 controls the whole apparatus, and limiting resistor 25 limits a current passed through light emitting element 2.

In the first exemplary embodiment, an (white-color) LED is used as light emitting element 2, and driving means 3 includes inverter 10, first to third switches (CMOS) 11, 12, and 26, and diode 27. An electric double layer capacitor is used as electric accumulation element 4, a Li-ion secondary battery is used as battery power supply 5, and an image capturing element (CMOS image sensor or CCD image sensor) is used as the light receiving element.

Driving means 3 is configured so as to be able to switch between a state (electric accumulation state) in which the electric power supplied from battery power supply 5 is accumulated in electric accumulation element 4 by connecting electric accumulation element 4 and light emitting element 2 in parallel to each other with respect to battery power supply 5 and a state (discharge state) in which the electric power of the battery power supply 5 and the electric power accumulated by the electric accumulation element 4 are supplied to light emitting element 2 by connecting battery power supply 5, electric accumulation element 4, and light emitting element 2 in series.

The configurations of light emitting element driver 1 and mobile device 13 of the first exemplary embodiment are described above. An operation of light emitting element driver 1 of the first exemplary embodiment will be described below.

In the electric accumulation state, when controller 7 outputs an L signal, the L signal is applied to inputs of gates of first and second switches 11 and 12, thereby turning off (opening) first and second switches 11 and 12. On the other hand, the L signal is applied to an input of inverter 10 to apply an H signal to an input of a gate of third switch 26, thereby turning on (closing) third switch 26.

Therefore, because a current i1 is passed through a closed loop of diode 27, electric accumulation element 4, and third switch 26 from battery power supply 5, electric accumulation element 4 accumulates the electric power supplied from battery power supply 5. At this point, a voltage value of 3.6 V of the electric power supplied from battery power supply 5 is stepped down by a voltage value of 0.6 V with diode 27, so that electric accumulation element 4 can accumulate the electric power of a voltage value of 3.0 V. Although the voltage value of 3.0 V is also applied to light emitting element 2, light emitting element 2 does not emit the light because second switch 12 is turned off (opened).

In the discharge state, when controller 7 outputs an H signal in order to operate the circuit, the H signal is applied to the inputs of the gates of first and second switches 11 and 12, thereby turning on (closing) first and second switches 11 and 12. On the other hand, the H signal is applied to the input of inverter 10 to apply the L signal to the input of the gate of third switch 26, thereby turning off (opening) third switch 26.

Therefore, because a positive voltage side of battery power supply 5 and a negative voltage side of electric accumulation element 4 are connected, a current i2 is passed through a closed loop of first switch 11, electric accumulation element 4, limiting resistor 25, light emitting element 2, and second switch 12 from battery power supply 5, and battery power supply 5 and electric accumulation element 4 supply the electric power to light emitting element 2. At this point, the voltage value of 6.6 V in which the voltage value of 3.6 V of the electric power supplied from battery power supply 5 is added to the voltage value of 3.0 V of the electric power discharged from electric accumulation element 4 becomes larger than the voltage value of 4.0 V of the electric power in which light emitting element 2 emits the light.

Therefore, because the voltage enough to emit the light is applied to light emitting element 2, a transient current limited by limiting resistor 25 is passed through light emitting element 2, and light emitting element 2 emits the light. Light emitting element 2 continuously emits the light, until the voltage value in which the voltage value at battery power supply 5 and the voltage value at electric accumulation element 4 are added is smaller than the voltage value at which light emitting element 2 emits the light or until the L signal is output from controller 7 to cut off the current i2 passed through power generating element 2.

As described above, according to light emitting element driver 1 and mobile device 13 of the first exemplary embodiment, when electric accumulation element 4 accumulates the electric power supplied from battery power supply 5, driving means 3 connects electric accumulation element 4 and light emitting element 2 in parallel to each other with respect to battery power supply 5. When the electric power accumulated by electric accumulation element 4 is supplied to light emitting element 2, driving means 3 connects battery power supply 5, electric accumulation element 4, and light emitting element 2 in series.

Therefore, the voltage value, which can be supplied to light emitting element 2 while the voltage value of the electric power of battery power supply 5 and the voltage value of the electric power of electric accumulation element 4 are added, is set larger than the voltage value at which light emitting element 2 emits the light, which allows light emitting element 2 to emit the light. For example, it is not necessary to provide step-up unit 8, when the voltage value of 4.0 V of the electric power in which light emitting element 2 emits the light is more than the voltage value of 3.6 V of the electric power that can be supplied from battery power supply 5 and the voltage value of 2.5 V of the electric power that can be supplied from electric accumulation element 4. Additionally, it is not necessary to provide the plurality of electric accumulation elements 4, which allows the miniaturization of the apparatus to be achieved.

### Second Exemplary Embodiment

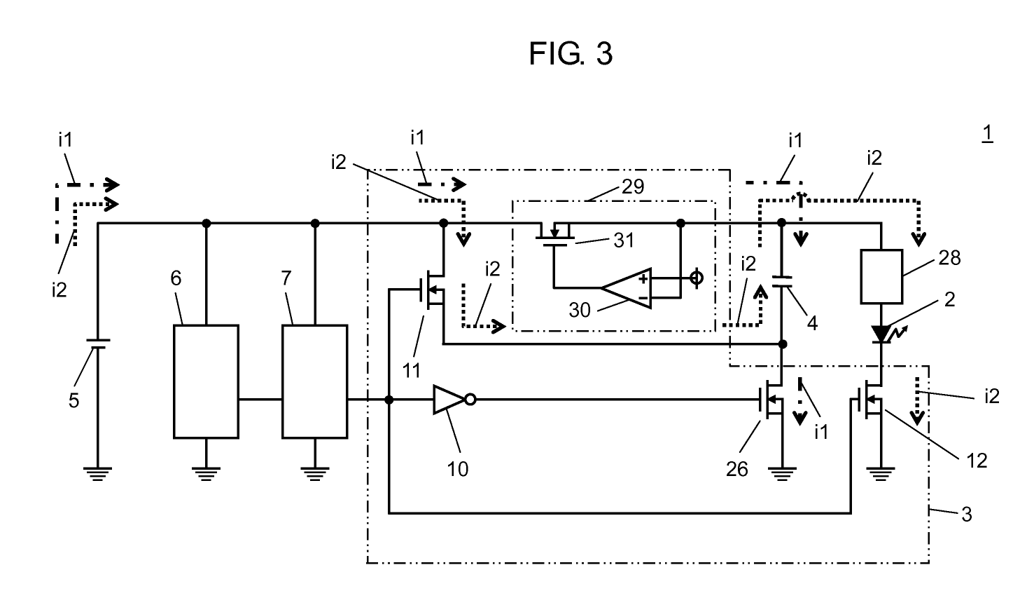

A light emitting element driver according to a second exemplary embodiment of the present invention will be described below with reference to FIG. 3. In FIG. 3, the same configuration or component as the first exemplary embodiment is designated by the same reference numeral as that of FIGS. 1A, 1B, and 2 unless otherwise noted.

Light emitting element driver 1 of the second exemplary embodiment illustrated in FIG. 3 solves a problem in that a life of light emitting element 2 becomes shortened or light emitting element is damaged (broken) when the current not lower than a predetermined current value is passed through light emitting element 2. Light emitting element driver 1 of the second exemplary embodiment also solves a problem in that the life of electric accumulation element 4 becomes shortened or electric accumulation element 4 is damaged (broken) when electric accumulation element 4 is left for a long time while the electric power not lower than a predetermined voltage value is accumulated in electric accumulation element 4.

Specifically, light emitting element driver 1 of the second exemplary embodiment differs from light emitting element driver 1 of the first exemplary embodiment in that light emitting element driver 1 of the second exemplary embodiment includes constant-current circuit unit 28 instead of limiting resistor 25. Additionally, light emitting element driver 1 of the second exemplary embodiment differs from light emitting element driver 1 of the first exemplary embodiment in that over-electric-accumulation preventing unit 29, which stops battery power supply 5 from supplying the electric power to electric accumulation element 4 when electric accumulation element 4 accumulates the electric power up to the predetermined voltage value, is provided in driving means 3 in order to prevent over-electric-accumulation of electric accumulation element 4. In light emitting element driver of the second exemplary embodiment, because other configurations are substantially identical to those of light emitting element driver 1 of the first exemplary embodiment, the description is omitted.

Driving means 3 is configured so as to be also able to switch to a state (hereinafter also referred to as a “standby state”), which differs from the electric accumulation state and the discharge state, namely, electric accumulation element 4 neither accumulates nor discharges the electric power. Over-electric-accumulation preventing unit 29 includes voltage detector 30 that detects that the accumulated voltage value at electric accumulation element 4 reaches a reference voltage value (for example, 2.5 V) and fourth switch (CMOS) 31 that cuts off the electric accumulation using an output signal of voltage detector 30.

Voltage detector 30 is connected such that the reference voltage value of 2.5 V that guarantees performance of electric accumulation element 4 is set to a positive (+) terminal of input terminals and such that a positive voltage of electric accumulation element 4 is applied to a negative (−) terminal of the input terminals. On the other hand, the gate of fourth switch 31 disposed between battery power supply 5 and electric accumulation element 4 is connected to an output terminal.

The configurations of light emitting element driver 1 of the second exemplary embodiment are described above. The operation of light emitting element driver 1 of the second exemplary embodiment will be described below.

In the electric accumulation state (initial state), when controller 7 outputs the L signal, third switch 26 is turned on (closed) while first and second switches 11 and 12 are turned off (opened). Because electric accumulation element 4 does not accumulate the electric power to the reference voltage value, the positive terminal side (reference voltage value) is an H level in voltage detector 30. Accordingly, voltage detector 30 outputs the H signal to apply the H signal to the input of the gate of fourth switch 31, thereby turning on (closing) fourth switch 31.

Therefore, because the current i1 is passed through a closed loop of fourth switch 31, electric accumulation element 4, and third switch 26 from battery power supply 5, electric accumulation element 4 accumulates the electric power supplied from battery power supply 5. When electric accumulation element 4 accumulates the electric power up to the reference voltage value (2.5 V), because the positive terminal side (reference voltage value) becomes an L level in voltage detector 30, voltage detector 30 outputs the L signal to turn off (open) fourth switch 31. Therefore, battery power supply 5 stops the supply of the electric power to electric accumulation element 4.

In the discharge state, when controller 7 outputs the H signal to operate the circuit, first and second switches 11 and 12 are turned on (closed). On the other hand, third switch 26 is turned off (opened). Fourth switch 31 remains turned off (opened). Therefore, the current i2 is passed through a closed loop of first switch 11, electric accumulation element 4, constant-current circuit unit 28, light emitting element 2, and second switch 12 from battery power supply 5.

Because the voltage enough to emit the light is applied to light emitting element 2, a constant current set by constant-current circuit unit 28 is passed through light emitting element 2, and light emitting element 2 emits the light. Even if the voltage value at electric accumulation element 4 becomes lower than the reference voltage value due to the discharge of electric accumulation element 4, because the voltage in which the voltage at battery power supply 5 and the voltage at electric accumulation element 4 are added is applied to the negative terminal of voltage detector 30, voltage detector 30 continuously outputs the L signal to turn off (open) fourth switch 31. Therefore, the electric power of electric accumulation element 4 is not discharged onto the side of battery power supply 5.

As described above, according to light emitting element driver 1 of the second exemplary embodiment, over-electric-accumulation preventing unit 29 stops battery power supply 5 from supplying the electric power to electric accumulation element 4 when electric accumulation element 3 accumulates the electric power up to the predetermined voltage value. Therefore, the over-electric-accumulation of electric accumulation element 4 is prevented, so that the damage (breakage) of electric accumulation element 4 can be prevented.

### Third Exemplary Embodiment

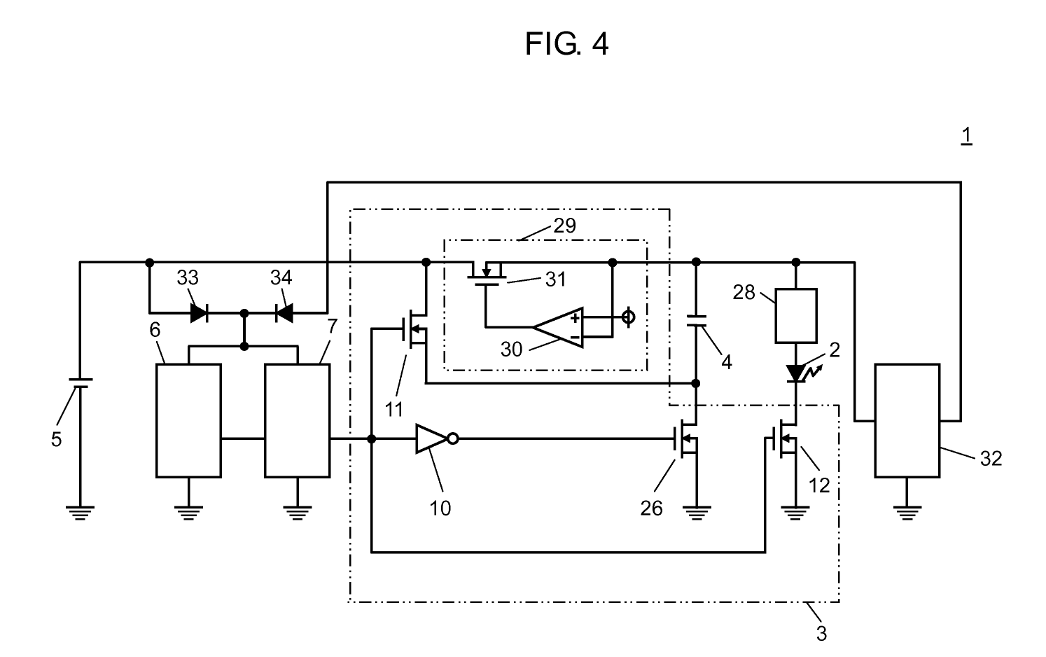

A light emitting element driver according to a third exemplary embodiment of the present invention will be described below with reference to FIG. 4. In FIG. 4, the same configuration or component as the first and second exemplary embodiments is designated by the same reference numeral as that of FIGS. 1A, 1B, 2, and 3 unless otherwise noted.

Light emitting element driver 1 of the third exemplary embodiment illustrated in FIG. 4 solves a problem in that, because the current equal to the light emitting current of light emitting element 2 flows from battery power supply 5 when light emitting element 2 emits the light, the voltage at the terminal of battery power supply 5 is decreased by an internal resistance of battery power supply 5 while the light emitting current of light emitting element 2 is kept at a predetermined current value, whereby sometimes a defect affects other components.

Specifically, light emitting element driver 1 of the third exemplary embodiment differs from light emitting element driver 1 of the second exemplary embodiment in that light emitting element driver 1 of the third exemplary embodiment includes constant-voltage circuit unit 32 that inputs the voltage, in which the voltage at battery power supply 5 and the voltage at electric accumulation element 4 are added, and outputs the electric power having the same voltage value as battery power supply 5 when light emitting element 2 emits the light. Additionally, light emitting element driver 1 of the third exemplary embodiment differs from light emitting element driver 1 of the second exemplary embodiment in that camera unit 6 and controller 7 supply the electric power from both battery power supply 5 and constant-voltage circuit unit 32 through first and second diodes 33 and 34. In light emitting element driver 1 of the third exemplary embodiment, because other configurations are substantially identical to those of light emitting element driver 1 of the second exemplary embodiment, the description is omitted.

According to light emitting element driver 1 of the third exemplary embodiment, while camera unit 6 and controller 7 supply the electric power from battery power supply 5 through first diode 33, camera unit 6 and controller 7 supply the electric power from both battery power supply 5 and constant-voltage circuit unit 32 when light emitting element 2 emits the light. Accordingly, even if the voltage at the terminal of battery power supply 5 is decreased when light emitting element 2 emits the light, because the electric power is supplied from constant-voltage circuit unit 32, the defect can be prevented from affecting camera unit 6 and controller 7.

### Fourth Exemplary Embodiment

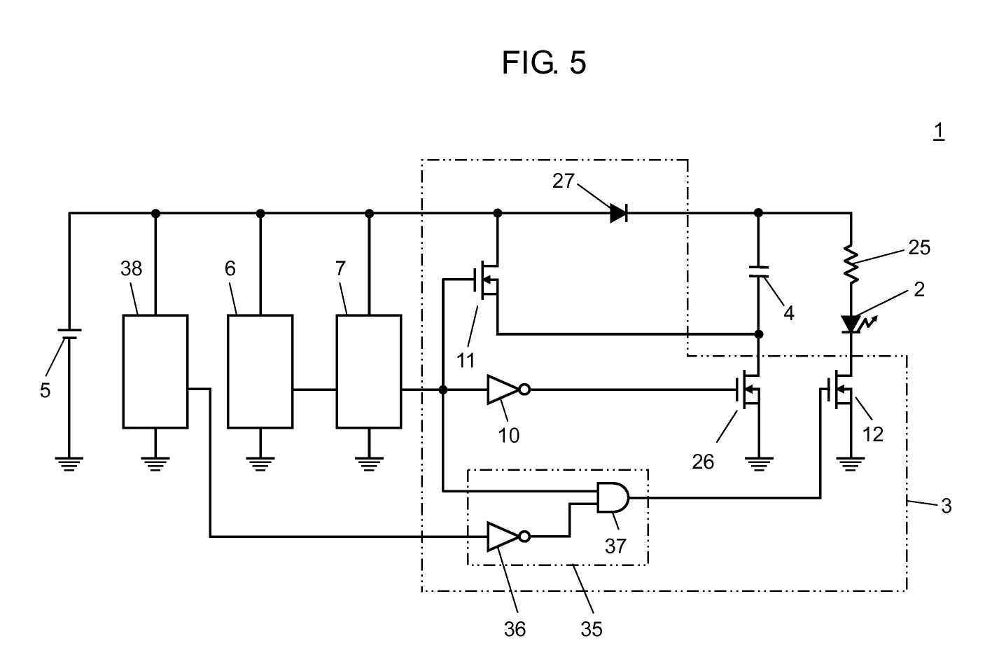

A light emitting element driver according to a fourth exemplary embodiment of the present invention will be described below with reference to FIG. 5. In FIG. 5, the same configuration or component as the first exemplary embodiment is designated by the same reference numeral as that of FIGS. 1A, 1B, and 2 unless otherwise noted.

Light emitting element driver 1 of the fourth exemplary embodiment illustrated in FIG. 5 solves a problem in that, because the electric power is supplied from battery power supply 5 to FR circuit 38 when RF circuit 38 conducts radio communication with the outside, when the communication of RF circuit 38 and the light emission of light emitting element 2 occur simultaneously, due to the decrease (deficiency) in voltage at battery power supply 5, sometimes RF circuit 38 stops or malfunctions or light emitting element 2 insufficiently emits the light (with a deficiency in light emission amount).

Specifically, light emitting element driver 1 of the fourth exemplary embodiment differs from light emitting element driver 1 of the first exemplary embodiment in that light emitting element driver 1 of the fourth exemplary embodiment includes RF circuit 38 to which the electric power is supplied from battery power supply 5 when RF circuit 38 conducts radio communication with the outside, and in that driving means 3 includes light emission preventing unit 35 that prevents the electric power from being supplied to light emitting element 2 in order to prevent the light emission of light emitting element 2 while RF circuit 38 conducts communication. In light emitting element driver of the fourth exemplary embodiment, because other configurations are substantially identical to those of light emitting element driver 1 of the first exemplary embodiment, the description is omitted.

RF circuit 38 is connected to battery power supply 5. RF circuit 38 is connected in parallel to camera unit 6 and controller 7 with respect to battery power supply 5, and RF circuit 38 is also connected in parallel to light emitting element 2. The case in which RF circuit 38 conducts communication includes not only the case in which RF circuit 38 conducts communication based on an intention of a user, for example, the communication is conducted with another mobile phone (mobile station) or RF circuit 38 is connected to the Internet (active communication), but also the case in which RF circuit 38 conducts communication irrespective of the intention of the user, for example, RF circuit 38 conducts communication by a polling operation (checking operation of base station) to send back a radio wave received from a base station (inactive communication).

In the fourth exemplary embodiment, light emission preventing unit 35 includes inverter (NOT gate) 36 and AND gate 37. The output signal from RF circuit 38 is applied to an input of inverter 36. The output signal from controller 7 is applied to a first input of AND gate 37, and the output signal from inverter 36 is applied to a second input of AND gate 37.

The configurations of light emitting element driver 1 of the fourth exemplary embodiment are described above. The operation of light emitting element driver 1 of the fourth exemplary embodiment will be described below.

In the electric accumulation state, when controller 7 outputs the L signal, the L signal is applied to the input of the gate of first switch 11, thereby turning off (opening) first switch 11. On the other hand, the L signal is applied to the input of inverter 10 to apply the H signal to the input of the gate of third switch 26, thereby turning on (closing) third switch 26.

Because the L signal is also applied from controller 7 to the first input of AND gate 37, AND gate 37 outputs the L signal irrespective of an output signal (that is, second input) from RF circuit 38 (inverter 36). Because the L signal is applied to the input of the gate of second switch 12, second switch 12 is turned off (opened).

Therefore, because the current is passed through the closed loop of diode 27, electric accumulation element 4, and third switch 26 from battery power supply 5, electric accumulation element 4 accumulates the electric power supplied from battery power supply 5. Although the voltage is also applied to light emitting element 2, light emitting element does not emit the light because second switch 12 is turned off (opened).

In the discharge state, when controller 7 outputs the H signal in order to operate the circuit, the H signal is applied to the input of the gate of first switch 11, thereby turning on (closing) first switch 11. On the other hand, the H signal is applied to the input of inverter 10 to apply the L signal to the input of the gate of third switch 26, thereby turning off (opening) third switch 26. The H signal is also applied from controller 7 to the first input of AND gate 37.

Accordingly, because RF circuit 38 outputs the H signal while conducting communication, the L signal is applied to the second input of AND gate 37 through inverter 36. Because AND gate 37 outputs the L signal, the L signal is applied to the input of the gate of second switch 12, and second switch 12 is turned off (opened). As a result, light emitting element 2 can be prevented from emitting the light.

On the other hand, because RF circuit 38 outputs the L signal while not conducting communication, the H signal is applied to the second input of AND gate 37 through inverter 36. Because AND gate 37 outputs the H signal, the H signal is applied to the input of the gate of second switch 12, and second switch 12 is turned on (closed). As a result, the current is passed through the closed loop of first switch 11, electric accumulation element 4, limiting resistor 25, light emitting element 2, and second switch 12 from battery power supply 5, and light emitting element 2 can emit the light.

According to light emitting element driver 1 of the fourth exemplary embodiment having the above configuration, the voltage at battery power supply 5 is decreased, because battery power supply 5 supplies the electric power when RF circuit 38 conducts communication with the outside. However, light emission preventing unit 35 prevents the electric power from being supplied to light emitting element 2 while RF circuit 38 conducts communication, so that light emitting element 2 can be prevented from emitting the light while the voltage at battery power supply 5 is decreased. Therefore, the stop or the malfunction of RF circuit 38, which is caused by the deficiency in electric power, can be prevented or the insufficient light emission of light emitting element 2, which is caused by the deficiency in electric power, can be prevented.

The light emitting element driver and the mobile device according to the present invention are not limited to the above exemplary embodiments, but various changes can be made without departing from the scope of the present invention. The configurations or methods of the plurality of exemplary embodiments may arbitrarily be combined, or the configuration or method of one exemplary embodiment may be applied to the configuration or method of another exemplary embodiment.

1. A light emitting element driver comprising:
a light emitting element;
driving means for driving the light emitting element;
an electric accumulation element that can accumulate electric power; and
a battery power supply that can supply the electric power to the driving means and the electric accumulation element, wherein
the driving means is configured so as to switch between a state in which the electric accumulation element accumulates the electric power supplied from the battery power supply and a state in which the electric accumulation element supplies the accumulated electric power to the light emitting element,
the electric accumulation element and the light emitting element are connected in parallel to each other with respect to the battery power supply when the electric accumulation element accumulates the electric power supplied from the battery power supply, and the battery power supply, the electric accumulation element, and the light emitting element are connected in series when the electric accumulation element supplies the accumulated electric power to the light emitting element.

2. The light emitting element driver according to claim 1, wherein the electric accumulation element is an electric double layer capacitor.

3. The light emitting element driver according to claim 1, wherein the driving means further includes an over-electric-accumulation preventing unit that stops the battery power supply from supplying the electric power to the electric accumulation element when the electric accumulation element accumulates the electric power up to a predetermined voltage value.

4. The light emitting element driver according to claim 1, further comprising:
an RF circuit to which the electric power is supplied from the battery power supply when the RF circuit conducts radio communication with an outside; and
a light emission preventing unit that prevents the driving means from supplying the electric power to the light emitting element while the RF circuit conducts communication.

5. A mobile device comprising the light emitting element driver according to claim 1.

6. The mobile device according to claim 5, further comprising:
an optical system that focuses light; and
a light receiving element that receives the light focused by the optical system.

7. The light emitting element driver according to claim 2, wherein the driving means further includes an over-electric-accumulation preventing unit that stops the battery power supply from supplying the electric power to the electric accumulation element when the electric accumulation element accumulates the electric power up to a predetermined voltage value.

8. The light emitting element driver according to claim 2, further comprising:
an RF circuit to which the electric power is supplied from the battery power supply when the RF circuit conducts radio communication with an outside; and
a light emission preventing unit that prevents the driving means from supplying the electric power to the light emitting element while the RF circuit conducts communication.

9. A mobile device comprising the light emitting element driver according to claim 2.

10. The mobile device according to claim 9, further comprising:
an optical system that focuses light; and
a light receiving element that receives the light focused by the optical system.
